(19) United States
(12) Patent Application Publication
(10) Pub. No.: US 2015/0199412 A1
(43) Pub. Date: Jul. 16, 2015

(54) MOBILE COMMUNICATIONS DEVICE, NON-TRANSITORY COMPUTER-READABLE MEDIUM AND METHOD FOR DISPLAYING A SEARCH RESULT COVER PAGE AND SWITCHING FROM THE SEARCH RESULT COVER PAGE TO A SEARCH RESULT PAGE

(71) Applicant: HTC CORPORATION, Taoyuan City (TW)

(72) Inventors: Wendy Wai Mun CHAN, San Francisco, CA (US); Ying-Chieh LIN, New Taipei City (TW); Chih-Wei YANG, New Taipei City (TW)

(73) Assignee: HTC CORPORATION, Taoyuan City (TW)

(21) Appl. No.: 14/593,554

(22) Filed: Jan. 9, 2015

Related U.S. Application Data
(60) Provisional application No. 61/925,835, filed on Jan. 10, 2014.

(51) Int. Cl. G06F 17/30

(52) U.S. Cl. CPC G06F 17/30554; G06F 17/30864

(57) ABSTRACT

A mobile communications device, non-transitory computer-readable medium and method for displaying a search result cover page and switching from the search result cover page to a search result page are provided. A search result cover page that includes a content preview region is displayed on a display of a mobile communications device. The content preview region displays one or more pictures of one or more selected search result items that are selected from a plurality of search result items that are responsive to a search query. In response to receiving a user input that is applied to the content preview region, the display switches from the search result cover page to the search result page that includes the plurality of search result items.

### CROSS-REFERENCE TO RELATED APPLICATIONS

This nonprovisional application claims priority under 35 U.S.C. §119(e) on U.S. Provisional Patent Application No. 61/925,835, filed on Jan. 10, 2014, the entirety of which is incorporated herein by reference.

### BACKGROUND OF THE INVENTION

The present disclosure relates to a method for operating a mobile communications device, and more particularly, to a method for displaying a search result cover page and switching from the search result cover page to a search result page on a mobile communications device.

A search result cover page (SERP) is a web page that identifies search result items that are returned by a search engine in response to a search query. Each search result item may, for example, include a link to a resource, a title, an image, a text snippet that may identify where query terms occur within the resource, or other information.

### SUMMARY OF THE INVENTION

According to a first aspect of the present invention, a computer-implemented method comprises displaying, on a display of a mobile communications device, a search result cover page that includes a content preview region, wherein the content preview region displays one or more pictures of one or more selected search result items that are selected from a plurality of search result items that are responsive to a search query; and in response to receiving a user input that is applied to the content preview region, switching from the search result cover page to a search result page that includes the plurality of search result items.

According to a second aspect of the present invention, a mobile communications device comprises: a display; a processor connected to the display and configured to select one or more search result items from a plurality of search result items that are responsive to a search query, control the display to display a search result cover page that includes a content preview region, wherein the content preview region displays one or more pictures of the one or more selected search result items, and in response to receiving a user input that is applied to the content preview region, control the display to switch from the search result cover page to a search result page that includes the plurality of search result items.

According to a third aspect of the present invention, a non-transitory computer-readable medium contains a computer program product comprising mobile communications device executable instructions for displaying a search result cover page on a display of a mobile communications device and switching from the search result cover page to a search result page, and the mobile communications device executable instructions comprises: displaying, on the display of the mobile communications device, the search result cover page that includes a content preview region, wherein the content preview region displays one or more pictures of one or more selected search result items that are selected from a plurality of search result items that are responsive to a search query; and in response to receiving a user input that is applied to the content preview region, switching from the search result cover page to the search result page that includes the plurality of search result items.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 depicts an example search result cover page in accordance with an embodiment of the present invention;

FIG. 2 depicts an example search result page in accordance with an embodiment of the present invention;

FIG. 3 depicts an example search engine system for displaying an example search result cover page in accordance with an embodiment of the present invention;

FIG. 4 is a flowchart for displaying an example search result cover page in accordance with an embodiment of the present invention; and

FIG. 5 is a flowchart in accordance with another embodiment of the present invention.

### DETAILED DESCRIPTION OF THE ILLUSTRATED EMBODIMENTS

The present invention will now be described in detail with reference to the accompanying drawings, wherein the same reference numerals will be used to identify the same or similar elements throughout the several views. It should be noted that the drawings should be viewed in the direction of orientation of the reference numerals.

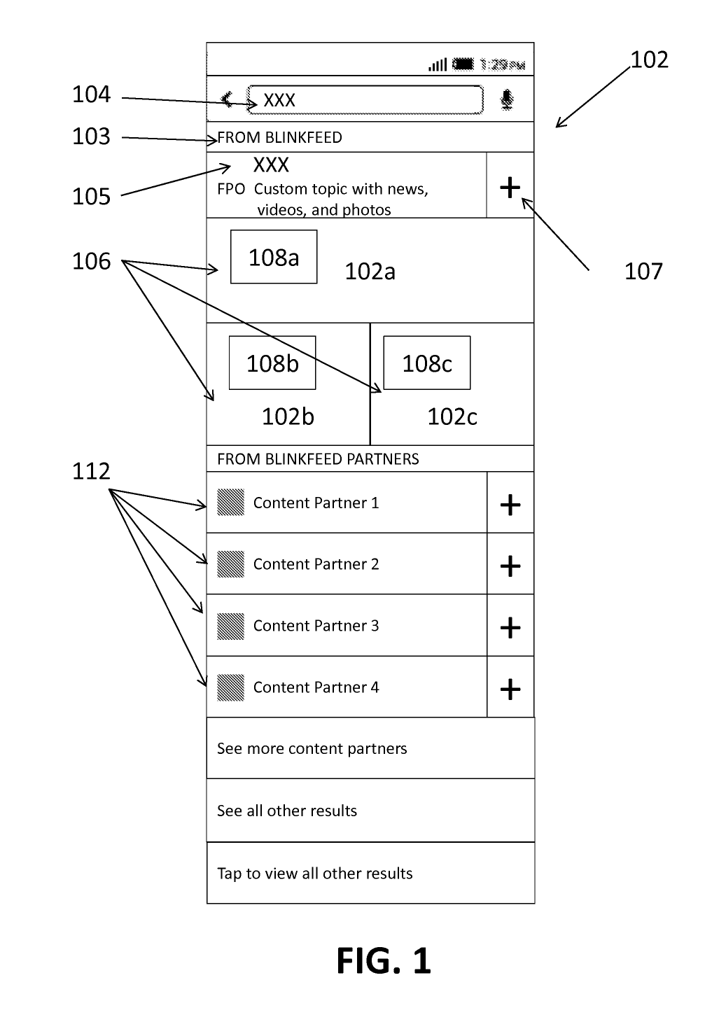

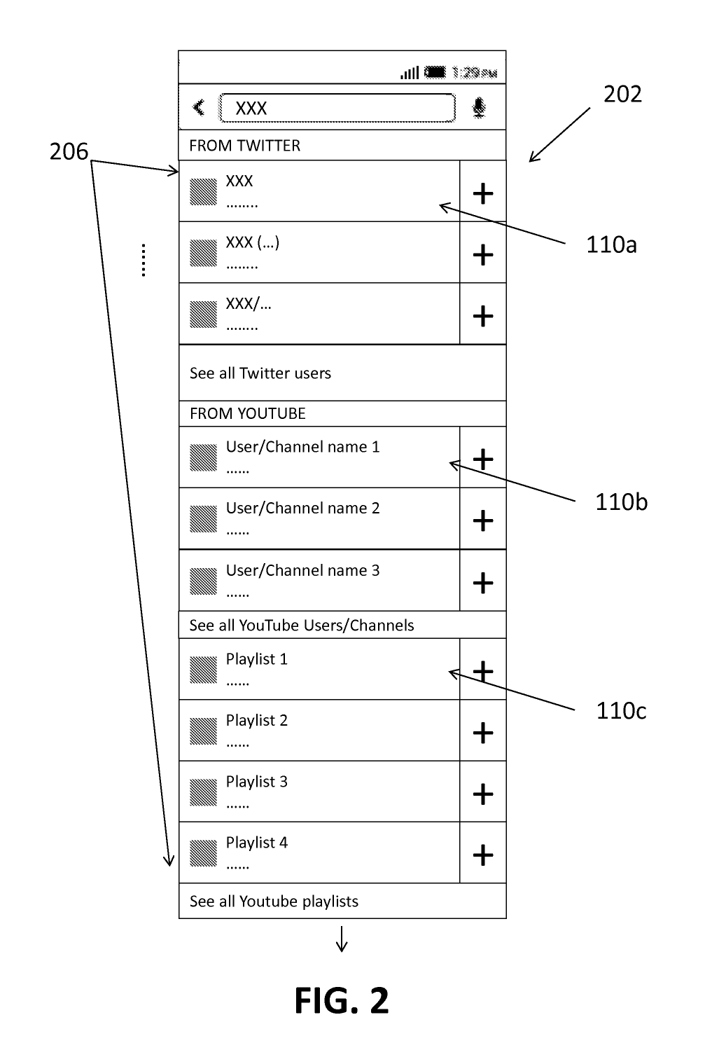

FIG. 1 depicts an example search result cover page 102 displayed on a display/screen of a mobile communications device, and FIG. 2 depicts an example search result page 202 displayed on a display/screen of a mobile communications device. The search result cover page 102 may be switched to the search result page 202 in response to a user input, e.g., based on detecting a tapping gesture.

In general, when the search result cover page 102 is displayed in response to receiving a search query input by the user, the search result cover page 102 includes a search query field 104 that displays the search query (e.g., “XXX” as shown in FIG. 1), and a content preview region 106 that displays preview information, such as one or more pictures of one or more selected search result items that are selected form a plurality of search result items that are responsive to a search query which is input to the search query field 104. When the search result page 202 is displayed in response to a user input, such as a tapping gesture, applied on the content preview region 106, the search result page 202 includes a content region 206 that displays a plurality of search result items that are responsive to the search query which is input to the search query field 104.

The plurality of search result items displayed on the content region 206 include all the selected search result items displayed on the content preview region 106 and additional search result items that are different from the selected search result items displayed on the content preview region 106.

In another embodiment, other regions may be included in the search result cover page 102 and the search result page 202, or certain of the depicted regions may be omitted.

In the illustrated embodiment, the search result cover page 102 includes the search query field 104 that is associated with the search query. The search result cover page 102 also includes the content preview region 106, which displays preview information, i.e., one or more pictures of one or more selected search result items that are selected from the search result items identified in response to the search query. For instance, as shown in the illustrated embodiment, the content preview region 106 may display three pictures 108a-108c, which respectively belong to three different selected search result items 110a-110c in response to the search query.

In some implementations, the pictures of the selected search result items displayed on the content preview region 106 may have textual information related to the selected search result item displayed thereon. In FIG. 1, for example, the picture 108a in the content preview region 106 has textual information related to the selected search result item 110a displayed thereon. The picture 108b in the content preview region 106 has textual information related to the selected search result item 110b displayed thereon. The picture 108c in the content preview region 106 has textual information related to the selected search result item 110b displayed beneath the picture 108c.

The content preview region 106 may give user a preview of several search result items in responsive to the search query. By placing the content preview region 106 near the top of the search result cover page 102, the user may quickly review the image during a top-to-bottom scan of the search result cover page 102, and may evaluate the contextual information included in the search result cover page 102 before evaluating detailed textual information relating to any particular search result item.

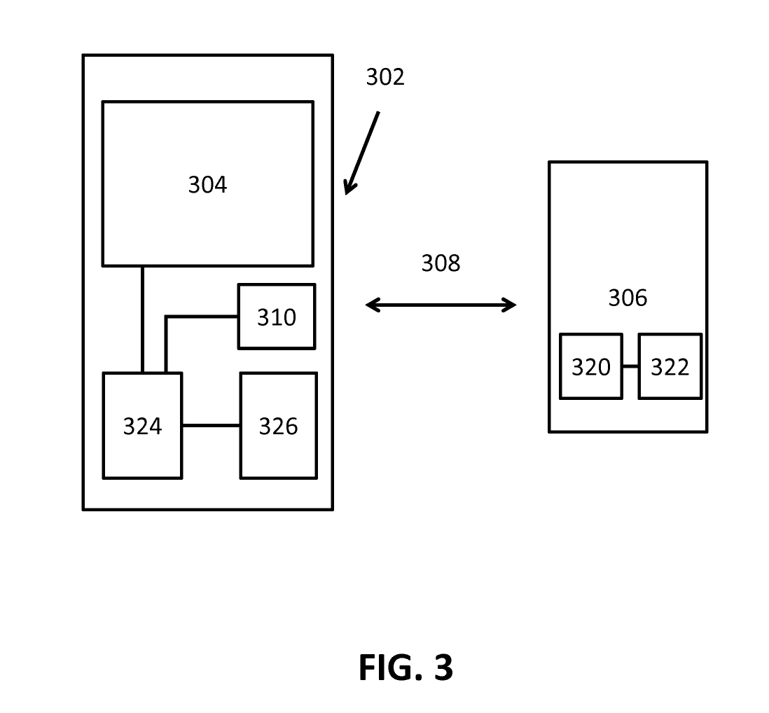

FIG. 3 is a block diagram of a system 300 in accordance with an embodiment of the present invention. In general, the system 300 includes a mobile communications device 302 (e.g., a smart phone) with a touchscreen display 304, where the touchscreen display 304 can be used as a graphical user interface (GUI) for the mobile communications device 302. The touchscreen display 304 can display the search result cover page 102. A number of components within the mobile communications device 302 provide for interaction with the mobile communications device 302. The mobile communications device 302 includes a processor 324 and a non-transitory memory device 326 coupled to the processor 324. The mobile communications device 302 can communicate with a server system 306 through a network 308 using a wireless interface 310. The network 308 can be Internet or a cellular network. For example, the mobile communications device 302 can direct telephone calls through a telephone network or through a data network using Voice over Internet Protocol (VoIP). In addition, the mobile communications device 302 can transmit other forms of data over the Internet, for example, data in the form of Hypertext Transfer Protocol (HTTP) requests that are directed at particular web sites. The mobile communications device 302 may receive responses, for example, in forms that can include, but are not limited to, mark-up code for generating web pages, media files, and electronic messages.

The server system 306 can include a search engine 320 and an index log 322. The search engine 320 can be provided as one or more computer programs and the index log 322 can be provided as one or more computer-readable storage media. The search engine 320 receives the search query. In response to receiving the search query, the search engine 320 processes the search query through one or more indices of the index log 322 to identify a plurality of search result items.

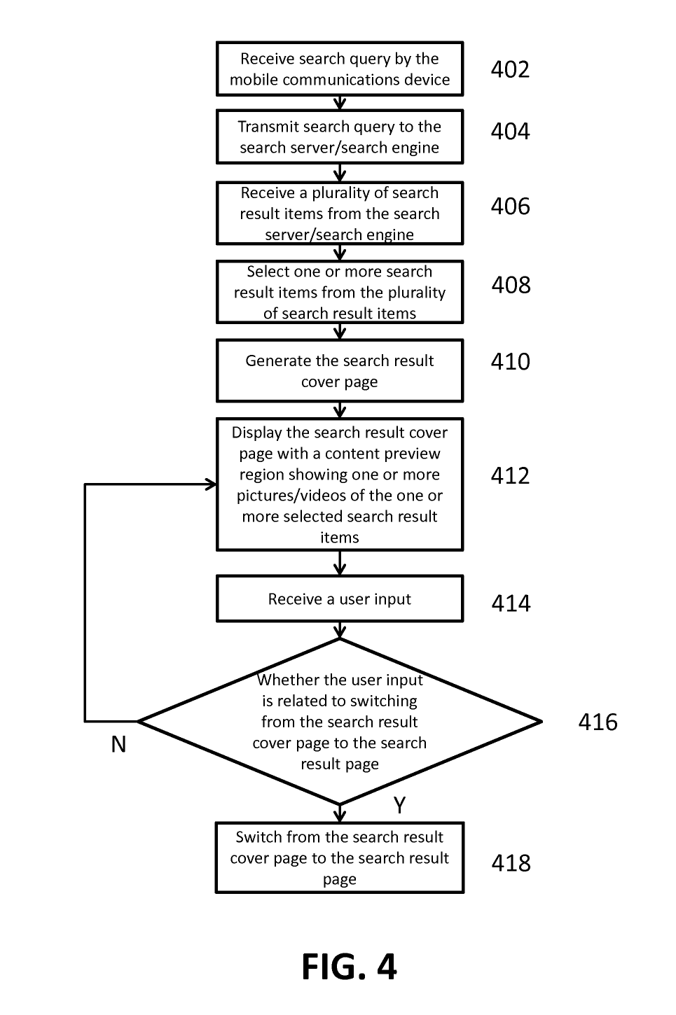

FIG. 4 is a flowchart of an example process 400 for displaying a search result cover page and switching to a search result page in accordance with an embodiment of the present invention. In an embodiment, the example process 400 can be executed by the mobile communications device 302 of FIG. 3, and the processor 324 can be used to execute the process 400. In one embodiment, computer-executable instructions of performing the process 400 are saved in the non-transitory memory device 326 or an external non-transitory memory device, or are part of the firmware of the processor 324, and are executable by the processor 324.

First, a search query is received (402) at the mobile communications device 302, and is transmitted (404) to the server system 306. For example, the search query is input to a search query field by a user. The search query field can be displayed on the touchscreen display of the mobile device.

The search query may be transmitted to a server system by a mobile communications device via the network. The search engine processes the search query to identify a plurality of search result items. In some implementations, the search result items can include news, video, tweet search result items from web pages. In some implementations, a plurality of search result items can be dependent on or independent of the geographic location of the mobile device. In an embodiment, the search engine then selects one or more selected search result items from the plurality of search result items based on whether the search result items include pictures to be displayed on the search result cover page. In another embodiment, the search engine selects one or more selected search result items based on whether the search result items have the search query in their titles. For example, the search result items can be news search result items and the search engine selects the news search result item that has the search query in the tile as a selected search result item. In still another embodiment, the search engine selects one or more selected search result items based on whether the search result items have the highest number of comments. For example, the search result items can be tweet search result items and the search engine selects the tweet search result item that has the highest number of comments as a selected search result item. In still another embodiment, the search engine selects one or more selected search result items based on whether the search result items have the highest number of hits/views. For example, the search result items can be YouTube video search result items and the search engine selects the YouTube video search result item that has the highest number of hits/views as a selected search result item.

The search engine obtains a plurality of search result items and transmits the plurality of search result items to the mobile communications device, where they are received (406).

The processor 324 of the mobile communications device selects one or more search result items from the plurality of search result items (408) and generates the search result cover page (410). The search result cover page is displayed based on the one or more selected search result items (412). For example, the mobile communications device may display the one or more pictures of the one or more selected search result items in a content preview region on the search result cover page via the touchscreen display.

User input is received (414). For example, the mobile communications device 302 receives user input via the touchscreen display. The user input can include the user providing a tapping gesture on the touchscreen display with respect to the search result cover page.

A determination is made whether the user input is related to switching from the search result cover page to the search result page (416). For example, the mobile communications device determines whether the user input, such as the tapping gesture, is related to switching from the search result cover page to the search result page based on whether the user input is applied to the content preview region. In one embodiment, if the user input is applied to the content preview region, the user input is determined to be related to switching from the search result cover page to the search result page. For example, the content preview region may display two or more different pictures/videos which respectively belong to two different selected search result items. In one embodiment, if the user input is applied to any of the two or more pictures in the content preview region, the user input is determined to be related to switching from the search result cover page to the search result page, and the display will switch from the search result cover page to the same search result page (418) no matter which one of the two or more pictures in the content preview region the user input is applied to.

In one embodiment, the search result cover page has a content provider region 103 that displays a name of a content provider that provides the plurality of search result items. The mobile device communications determines whether the user input, such as the tapping gesture, is related to switching from the search result cover page to the search result page based on whether the user input is applied to the content provider region 103. For example, if the user input is applied to the content provider region 103, the user input is determined to be related to switching from the search result cover page to the search result page, and the display will switch from the search result cover page to the same search result page (418).

In one embodiment, the search result cover page has a search query region 105 that displays the search query. The mobile device determines whether the user input, such as the tapping gesture, is related to switching from the search result cover page to the search result page based on whether the user input is applied to the search query region 105. For example, if the user input is applied to the search query region 105, the user input is determined to be related to switching from the search result cover page to the search result page, and the display will switch from the search result cover page to the same search result page (418).

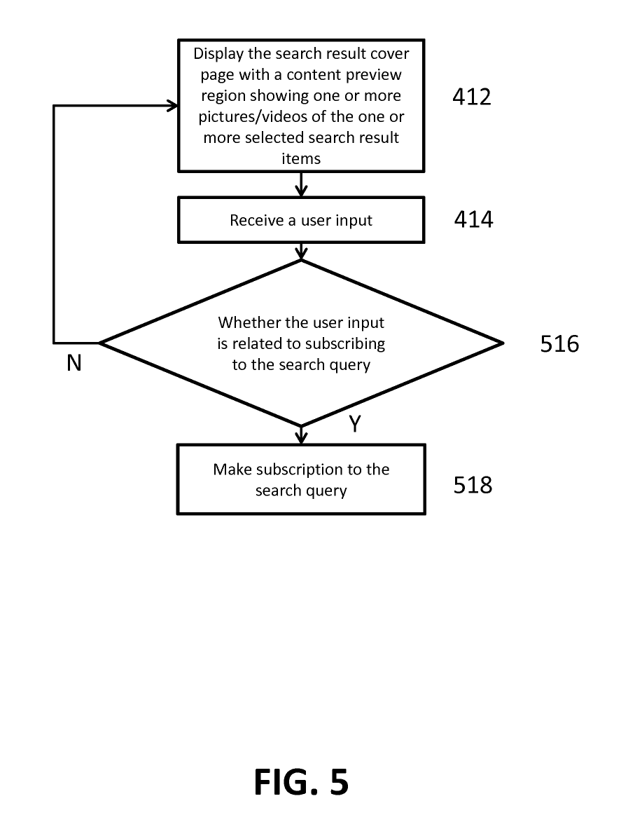

FIG. 5 is a flowchart in accordance with another embodiment of the present invention. In this embodiment, the search result cover page further has a subscription button 107 (see FIG. 1) that is disposed in a position next to the search query region 105. A determination is further made whether the user input is related to subscribing to the search query (516). For example, the mobile communications device determines whether the user input, such as the tapping gesture, is related to subscribing to the search query based on whether the user input is applied to the subscription button 107. In one embodiment, if the user input is applied to the subscription button 107, the user input is determined to be related to subscribing to the search query. If the user input is determined to be related to subscribing to the search query, a subscription to the search query occurs (518). For example, the mobile device communications determines that the tapping gesture provided by the user via the touchscreen display relates to subscribing to the search query, and as a result, subscribes to the search query as a custom topic which the user is interested in. The step 516 may be performed prior to, concurrently with or after the step 416.

In one embodiment, the search result cover page 102 further includes a content partner region 112 that displays one or more content partners that are responsive to the search query. In another embodiment, the search result cover page 102 further includes a service region that displays one or more services that are responsive to the search query.

Implementations of the present disclosure and all of the functional operations provided herein can be realized in digital electronic circuitry, or in computer software, firmware, or hardware, including the structures disclosed in this specification and their structural equivalents, or in combinations of one or more of them. Implementations of the present disclosure can be realized as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this present disclosure can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. Elements of a computer can include a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, implementations of the present disclosure can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

While this disclosure includes some specifics, these should not be construed as limitations on the scope of the disclosure or of what may be claimed, but rather as descriptions of features of example implementations of the disclosure. Certain features that are described in this disclosure in the context of separate implementations can also be provided in combination in a single implementation. Conversely, various features that are described in the context of a single implementation can also be provided in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the present disclosure have been described. Other implementations are within the scope of the following claims. For example, the actions recited in the claims can be performed in a different order and still achieve desirable results. A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A computer-implemented method comprising:
displaying, on a display of a mobile communications device, a search result cover page that includes a content preview region, wherein the content preview region displays one or more pictures of one or more selected search result items that are selected from a plurality of search result items that are responsive to a search query; and
in response to receiving a user input that is applied to the content preview region, switching from the search result cover page to a search result page that includes the plurality of search result items.

2. The method of claim 1, wherein one search result item of the one or more selected search result items is selected from the plurality of search result items based on whether the one search result item includes the search query in a title of the one search result item.

3. The method of claim 1, wherein one search result item of the one or more selected search result items is selected from the plurality of search result items based on whether the one search result item has a highest number of comments.

4. The method of claim 1, wherein one search result item of the one or more selected search result items is selected from the plurality of search result items based on whether the one search result item has a highest number of views.

5. The method of claim 1, wherein the content preview region displays two or more pictures of the one or more selected search result items, and the step of switching from the search result cover page to the search result page in response to receiving the user input that is applied to the content preview region further includes:
switching from the search result cover page to the search result page in response to receiving the user input no matter which one of the two or more pictures in the content preview region the user input is applied to.

6. The method of claim 5, wherein the search result cover page further includes a content provider region that displays a name of a content provider that provides the plurality of search result items, and the method further comprises:
in response to receiving a user input that is applied to the content provider region, switching from the search result cover page to the search result page that includes the plurality of search result items that are responsive to the search query.

7. The method of claim 1, wherein the step of switching from the search result cover page to the search result page in response to receiving the user input that is applied to the content preview region further includes:
switching from the search result cover page to the search result page in response to receiving the user input no matter where the user input is applied to in the content preview region.

8. The method of claim 7, wherein the search result cover page further includes a search query region that displays the search query, and the method further comprises:
in response to receiving a user input that is applied to the search query region, switching from the search result cover page to the search result page that includes the plurality of search result items that are responsive to the search query.

9. The method of claim 1, wherein the search result cover page further includes a subscription button, and the method further comprises:
in response to a user input that is applied to the subscription button, subscribing to the search query.

10. The method of claim 8, wherein the search result cover page further includes a content partner region that displays one or more content partners that are responsive to the search query.

11. The method of claim 9, wherein the search result cover page further includes a service region that displays one or more services that are responsive to the search query.

12. A mobile communications device comprising:
a display; and
a processor connected to the display and configured to
select one or more search result items from a plurality of search result items that are responsive to a search query,
control the display to display a search result cover page that includes a content preview region, wherein the content preview region displays one or more pictures of the one or more selected search result items, and
in response to receiving a user input that is applied to the content preview region, control the display to switch from the search result cover page to a search result page that includes the plurality of search result items.

13. The mobile communications device of claim 12, wherein the processor is configured to select one search result item of the one or more selected search result items based on whether the one search result item includes the search query in a title of the one search result item.

14. The mobile communications device of claim 12, wherein the processor is configured to select one search result item of the one or more selected search result items based on whether the one search result item has a highest number of comments.

15. The mobile communications device of claim 12, wherein the processor is configured to select one search result item of the one or more selected search result items based on whether the one search result item has a highest number of views.

16. The mobile communications device of claim 12, wherein the content preview region displays two or more pictures of the one or more selected search result items, and the processor is configured to control the display to switch from the search result cover page to the search result page in response to receiving the user input that is applied to the content preview region, no matter which one of the two or more pictures in the content preview region the user input is applied to.

17. The method of claim 16, wherein the search result cover page further includes a content provider region that displays a name of a content provider that provides the plurality of search result items, and the processor is configured to control the display to switch from the search result cover page to the search result page that includes the plurality of search result items that are responsive to the search query, in response to receiving a user input that is applied to the content provider region.

18. The mobile communications device of claim 12, wherein the processor is configured to control the display to switch from the search result cover page to the search result page in response to receiving the user input that is applied to the content preview region, no matter where the user input is applied to in the content preview region.

19. The method of claim 18, wherein the search result cover page further includes a search query region that displays the search query, and the processor is configured to control the display to switch from the search result cover page to the search result page that includes the plurality of search result items that are responsive to the search query, in response to receiving a user input that is applied to the search query region.

20. A non-transitory computer-readable medium containing a computer program product comprising mobile communications device executable instructions for displaying a search result cover page on a display of a mobile communications device and switching from the search result cover page to a search result page, the mobile communications device executable instructions comprising:
displaying, on the display of the mobile communications device, the search result cover page that includes a content preview region, wherein the content preview region displays one or more pictures of one or more selected search result items that are selected from a plurality of search result items that are responsive to a search query; and
in response to receiving a user input that is applied to the content preview region, switching from the search result cover page to the search result page that includes the plurality of search result items.
